(19) United States
(12) Patent Application Publication
(10) Pub. No.: US 2012/0018911 A1
(43) Pub. Date: Jan. 26, 2012

(54) Optical device and deflector formation process

(76) Inventor: Gabriel James Tambunga, Philadelphia, PA (US)

(21) Appl. No.: 12/804,386

(22) Filed: Jul. 21, 2010

(51) Int. Cl. G02B 1/00

(52) U.S. Cl. 264/1.36

(57) ABSTRACT

The Optical Device and Deflector Formation Process is a process where a non-permanent optical device or deflector is created: (1) within a medium by sources of energy that disrupts the properties of the media in a volume within a media; (2) within a vacuum or media by sources of energy that introduce specific aligned energies in the vacuum or media in a volume within a vacuum or media; or in combination of (1) and (2). A created Optical Device or Deflector is not contained within any boundaries that are composed of a media that is different from the media that surrounds the optical device or deflector. The process indicated in (1) consists of secondary and tertiary sources of energy: where the secondary sources can affect the energy, energy state and/or the orientation of specific molecules or particles, and tertiary sources are similar to secondary sources, however, makeup for deficiencies the secondary sources could not provide. The process indicated in (2) consists of secondary sources that introduce a specific array of arrays of energies that become the optical device or deflector, where tertiary sources may not be necessary unless they are assisting the secondary sources. The term “primary source” is reserved for waves, particles, molecules or objects that are deflected or affected by the created device. The optical device, in summary, causes a change in the primary sources momentum of particles, molecules, objects or waves when passing through or deflected from the optical device or deflector, respectively.

### BACKGROUND OF THE INVENTION

1. Field of Invention

The present invention relates generally to a process of forming optical devices and deflectors, and more specifically forming optical devices or deflectors by affecting the media and/or introducing aligned energy in the vacuum or media where the optical event or deflection is to occur.

2. Discussion of Prior Art

It is widely known that heat can change the Index of Refraction of media. For example, according to James C. Owens (January 1967/Vol. 6, No. 1/Applied Optics) the Index of Refraction of air can depend on the presence of specific heated molecules or atoms. A general statement can encompass all reasons why the Index of Refraction changes for any media: the Index of Refraction changes when the electronic states of the molecules or atoms, which are equivalent to the energy values of the wavelengths that pass through the media, within the media are changed. The heat within the media causes the vibrational, rotational and/or translational motion of molecules and/or atoms that causes the excitation of the electronic states by transfer of energy. The present invention will cause specific excitation of specific molecules and/or atoms within the media by direct excitation with applied energy (e.g. electromagnetic radiation) or indirect excitation by causing specific molecules and/or atoms in a volume or plane within the media to have an increased vibrational, rotational and/or translational motion that will cause the targeted molecules or atoms to have an increase in specific electronic states. This control of direct or indirect excitation of molecules and/or atoms can cause the control of optical effects or deflections within a media.

Currently, to produce specific types of optical events the placement of materials within a media is required (e.g. glass within air). Typically the material is composed of a media that is different than the media the material is placed in. It appears the prior art does not teach or suggest affecting the media and/or introducing aligned energy in the vacuum or media, where the optical event or deflection is to occur, to form a non-permanent optical device or deflector in a volume within the vacuum or media. There has been interest in the past in forming permanent lenses with the assistance of energy beams, such as ultraviolet light.

U.S. Pat. No. 5,422,046 discusses a method of casting plastic lenses by the use of ultraviolet light that heats a mold that is immersed in a cooling liquid. U.S. Pat. No. 4,044,222 discusses the use of energy beams in thin films to produce apertures.

The need for non-permanent lenses can be valuable in that an apparatus is not necessary for holding a non-permanent optical device, and cleaning of the optical device would not be necessary. Other advantages are: if a change in an optical device is necessary, the possible long process of forming the optical device can be reduced, such as in the formation of large telescope lenses; optical devices can be placed in spaces that can otherwise be difficult for a permanent lens, such as deep within a substrate.

### REFERENCES CITED

### U.S. Patent Documents

| | | |
|---|---|---|
| 5,422,046 | June 1995 | Tarshiani |
| 4,044,222 | August 1977 | Kestenbaum |

### OTHER PUBLICATIONS

Owens, James C: Optical Refractive Index of Air: Dependence on Pressure, Temperature and Composition; Applied Optics, Vol. 6, No. 1, January 1967, pp. 51-59.

### SUMMARY OF THE INVENTION

The purpose of the optical device or deflector is to perform an optical event or deflection, respectively, of a primary source of energy that moves through or is deflected from the optical device or deflector, respectively. This source of energy, or primary source, includes, but not limited to, waves (i.e. electromagnetic radiation), particles, molecules or objects. The present invention provides a process of forming an optical device or deflector. The optical device or deflector is created: (1) within a medium by sources of energy that disrupts the properties of the media; (2) within a vacuum or media by sources of energy that introduces a specific array of energies in the vacuum or media; or in combination of (1) and (2).

For an optical device or deflector that is created as indicated in (1) above, the process consists of secondary and tertiary sources of energy, where the objective of the secondary and tertiary sources is to modify or disrupts the media by direct or indirect excitation of specific electronic states at the same energy of the primary source to affect the primary source to undergo an optical event or deflection when the modified media is encountered. The secondary and tertiary sources of energy include, but not limited to, waves (e.g. electromagnetic radiation), particles, molecules or objects. The secondary sources directly and/or indirectly affect molecules, particles or objects that have a direct affect on the primary source. The effect of the secondary sources on the targeted molecules, particles and objects include, but not limited to, polarization, transfer of energy and changing the energy states. The tertiary sources perform the same function as the secondary sources except make up for deficiencies the secondary sources could not provide, such as providing a transfer of energy to targeted molecules, particles or objects to reduce spatial deficiencies. The secondary sources and tertiary sources will be directed to modify the media within a volume or plane of the media and be directed toward a specific location, so the primary source can be encountered with success.

For an optical device or deflector that is created as indicated in (2) above, the process consists of secondary and tertiary sources of energy, where the objective of the secondary and tertiary sources is to create an array of energy to modify the path of the primary source to undergo the optical event or deflection. The secondary and tertiary sources of energy include, but not limited to, waves (e.g. electromagnetic radiation), particles, molecules or objects. The secondary sources directly affect the primary source. The affect of the secondary sources on the primary sources can vary depending on the optical event or deflection desired. The tertiary sources can perform the same function as the secondary sources except make up for deficiencies the secondary sources could not provide, or affect the secondary sources to have more or less of the affect on the primary source. The secondary sources and tertiary sources will be directed to form a specific volume or plane within the media and be directed toward a specific location, so the primary source can be encountered with success.

Both methods of forming an optical device or deflector can be used succinctly for the benefit of a single or multiple optical events or deflections. The optical device causes a change in momentum of particles, molecules, objects or waves when passing through or deflected from the optical device or deflector, respectively. Therefore, it is possible for the particles, molecules, objects or waves to have an increase in momentum after encountering the optical device or deflector. Though the title of this process contains the words Optical Device, this process includes wavelengths outside the visible spectrum. Furthermore, when the particles, molecules, objects or waves encounter a formed device events that resemble an optical event may occur. As a result, the term optical device will be used to describe the formed device that causes events that resemble an optical event.

Accordingly, it is an object of the present process to form an optical device or deflector by affecting the media and/or introducing an array of energy in a vacuum or media, where the optical event or deflection is to occur.

These and additional objects, features, benefits and advantages of the present invention will become apparent from the following specification.

### DESCRIPTION OF PROCESS

I claim the benefit of the provisional application 61/276,807 filed on Sep. 17, 2009. The following is the description of the process of forming an optical device or deflector: by disrupting the media; introducing an array in a vacuum or media; and disrupting the media and introducing an array in the media. The process is broken down into steps where descriptions of each type of formation, formation by disrupting the media and formation by introducing an array or arrays in a vacuum or media, and formation by disrupting the media and introducing an array or arrays in a media, are specified within the steps.
(a) Determine the wave and/or mass that will undergo the optical event or deflection. The waves can include, but not limited to, electromagnetic radiation and sound waves. The mass can include, but not limited to, particles, molecules and objects.
(b) Choose the optical event or deflection to occur with the waves and/or mass from (a). This step includes determining the intensity of the wave and/or mass of the optical event or deflection. This step also includes determining the direction and location of the wave and/or mass before and after encountering the formed optical device or deflector. This step also includes determining the media or vacuum this optical event or deflection will occur in. The media can be a solid, liquid or gas. Determine if a change in momentum is desired after encountering the optical device or deflector.
(c) Choose the primary source that will emit the wave and/or mass from (a) with the requirements and information from (b).
(d) Choose the location of where the mass and/or wave will be detected, after encountering the optical device or deflector, considering the requirements from (b).
(e) Determine the disruption of media and/or array(s) necessary for the optical event or deflection of (b) to occur.
   Optical Event by Disrupting Media: Specific particles, molecules and/or objects can have a direct and/or indirect effect on the waves and/or mass from (a) and (b). For the optical event or deflection to occur perturbing specific particles, molecules, and/or objects in the media may be necessary for the direct and/or indirect effect on the waves and/or mass from (a) and (b). Determine the specific particles, molecules and/or objects to be perturbed that will have a direct and/or indirect effect on the waves and/or mass from (a) and (b). Determine the perturbation of the specific particles, molecules, and/or objects in the media necessary for the optical event or deflection to occur which can include, but not limited to: changing specific electronic energy states by direct excitation where the electronic energy states and direct excitation energy are at the same energy as the waves and/or mass from (a) and (b); indirect excitation by changing rotational motion, changing vibrational motion, changing transverse motion, and changing the density of perturbed particles, molecules, and/or objects in the media that will cause a change in electronic energy states of the specific particles, molecules, and/or objects that are at the same energy as the waves and/or mass from (a) and (b). For the indirect excitation, the particles, molecules and/or objects in the media with changed rotational motion, vibrational motion, transverse motion, and/or density may be different than, though cause, the particles, molecules, and/or objects in the media with the changed electronic energy states. The volume or plane over which the perturbation will occur is important in assisting the optical event or deflection. Determine the volume or plane of over which the disrupted media will occur, which includes determining the dimensions of the volume or plane. This determination may be dependent on the perturbation of the media.
   Optical Event by Introducing an Array: For the vacuum or media an array or arrays of energy may be necessary in guiding the waves and/or mass from (a) and (b) to the optical event or deflection in (b). Determine the energies, intensity of energies and pattern(s) necessary for the array or arrays for the optical event or deflection to occur. This includes determining energies, intensity of energies, patterns in all three dimensions, and the direction of each array in the pattern and the volume or plane necessary for the optical event or deflection, specified in (a) and (b), to occur. The energies can be, but not limited to single or multiple waves, particles, molecules and objects.
   Optical Event by Disrupting Media and Introducing an Array or Arrays: An array or arrays of energy and a perturbing of specific particles, molecules, and/or objects in the media may be necessary to cause the optical event or deflection in (b) to occur. The determination of the disruption of media and array(s) are determined identically as indicated above. The determination of the disruption of media and array(s) can be determined: independently but considering the effects of the other formation and put together to form the optical device; succinctly, to form the complete optical device.

(f) Determine the secondary sources that will meet the requirements stated in (e). The secondary sources can include, but not limited to, waves, particles, molecules, objects and/or physical compression.
(g) Determine the tertiary sources that will assist the secondary sources in meeting the requirements stated in (e). The tertiary sources can include, but not limited to, waves, particles, molecules and/or objects.
(h) Activate secondary sources and tertiary sources.
(i) Activate the primary source for the optical event or deflection to occur.
   Due to different types of optical events or deflections: not all steps will be necessary; not all steps will be needed in the specific order; some steps may be repeated. A value or specification chosen/determined for step (e) may affect other values or specifications in step (e).

### BRIEF DESCRIPTION OF THE DRAWINGS

FIG. 1 is a side cross sectional view of a formed optical device in a gas media in accordance with the Optical Device and Deflector Formation Process.

FIG. 2 is a side cross sectional view of a formed optical device in a vacuum in accordance with the Optical Device and Deflector Formation Process.

FIG. 3 is a side cross sectional view of a formed deflector in a gas media in accordance with the Optical Device and Deflector Formation Process.

FIG. 4 is a side cross sectional view of a formed deflector in a vacuum in accordance with the Optical Device and Deflector Formation Process.

FIG. 5 is a side cross sectional view of a formed optical device in a gas media in accordance with the Optical Device and Deflector Formation Process.

FIG. 6 is a side cross sectional view of a formed deflector in a vacuum in accordance with the Optical Device and Deflector Formation Process.

### DETAILED DESCRIPTION OF PREFERRED EVENTS

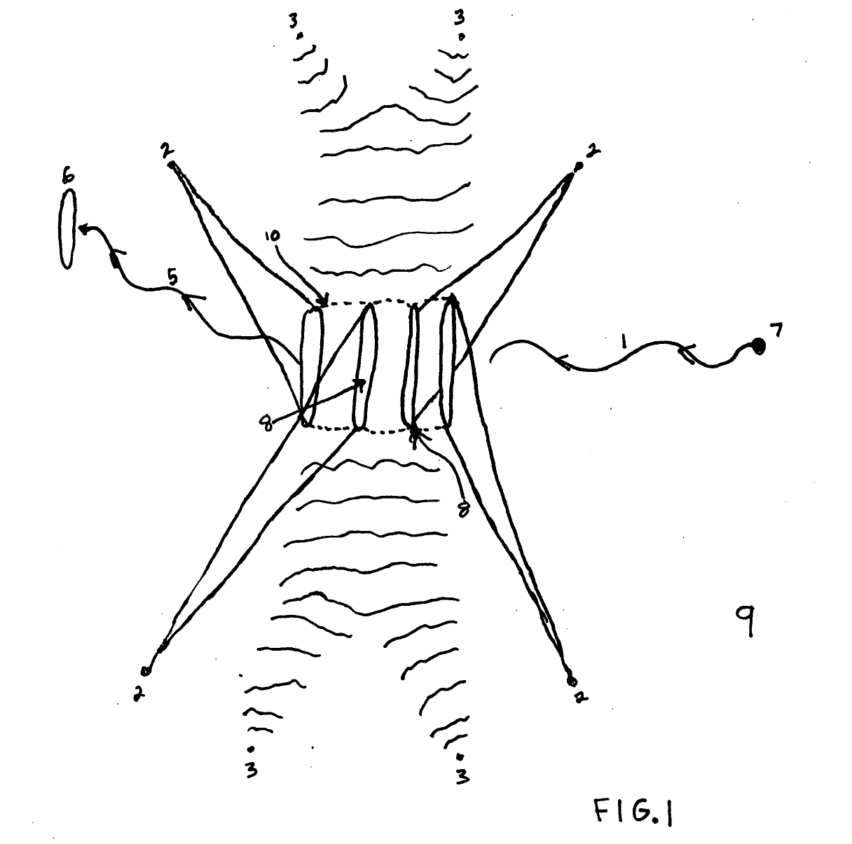

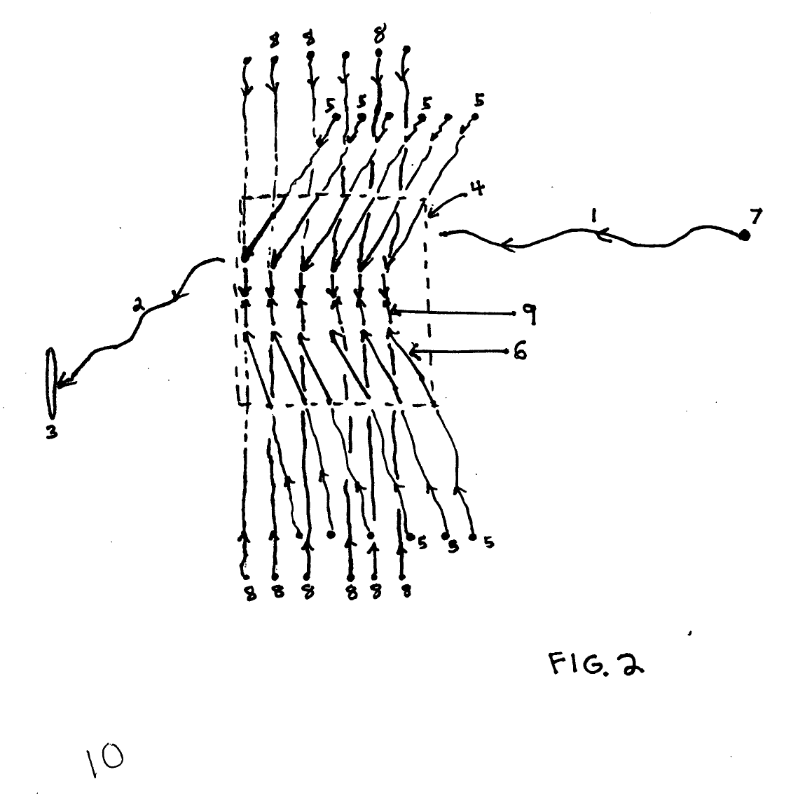

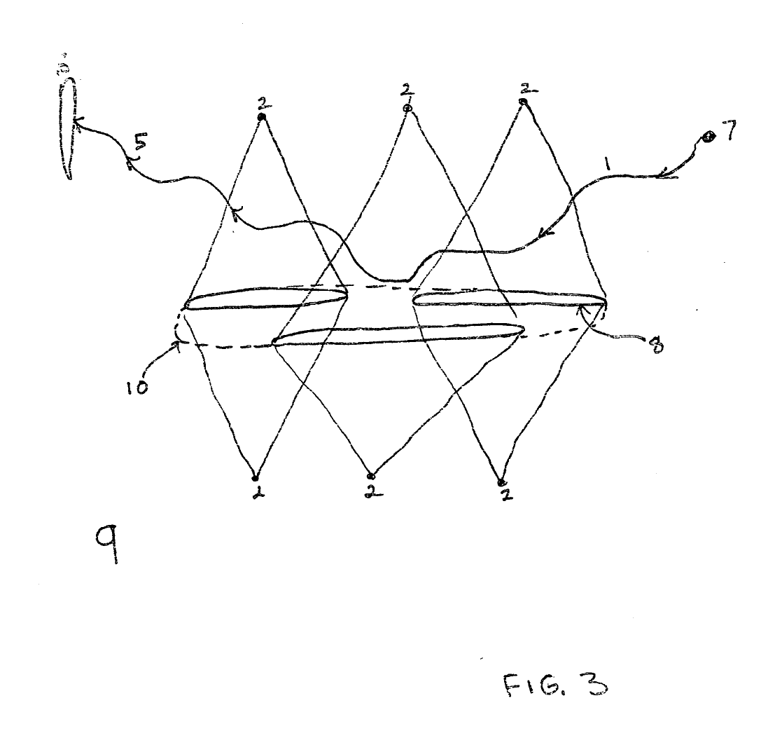

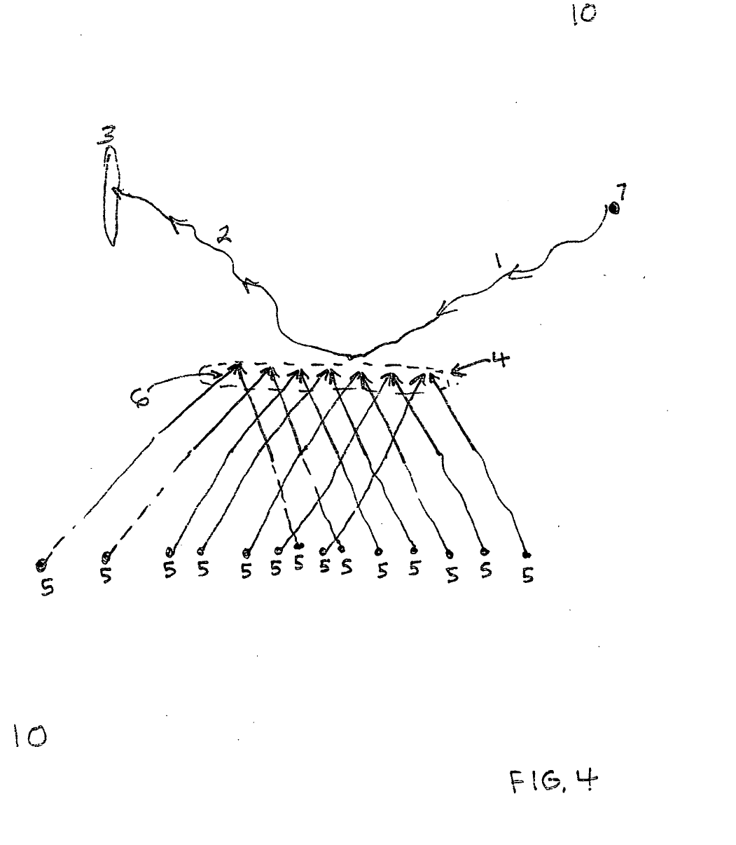

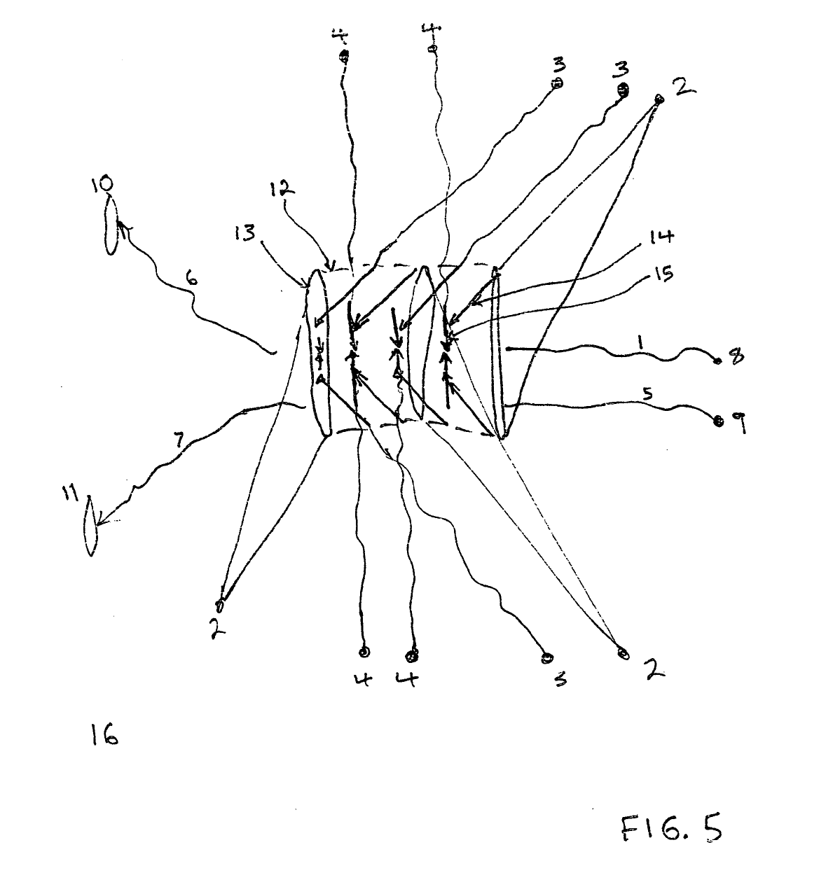

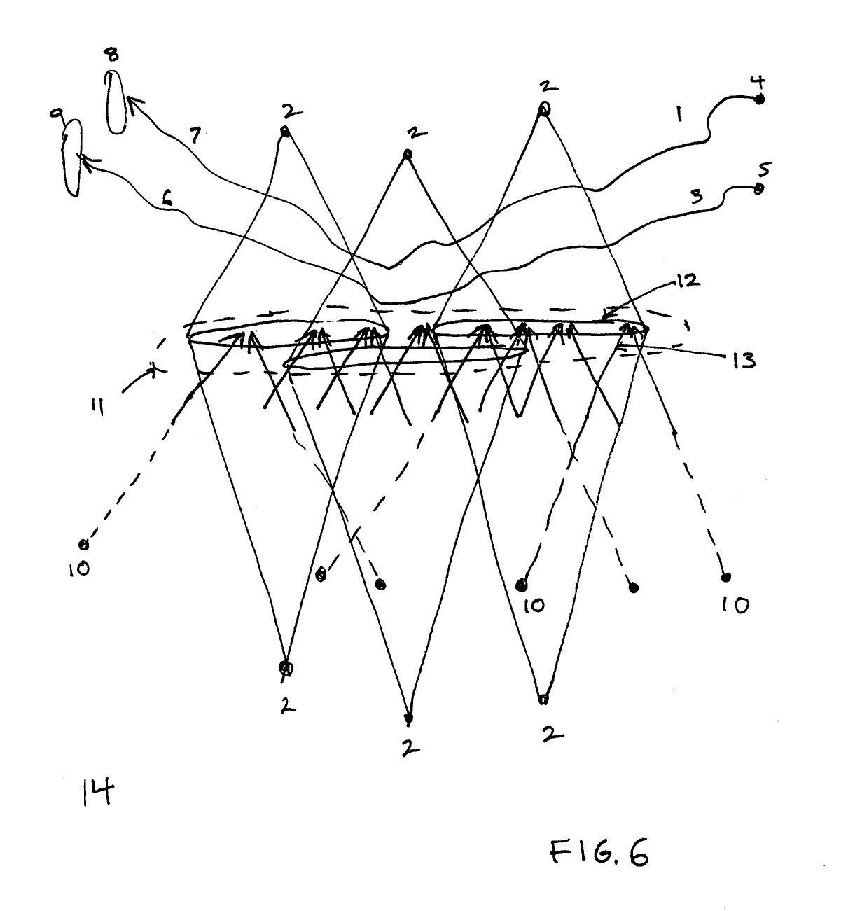

With reference now to the drawings, and particularly to FIG. 1, there is shown a cross sectional view of a formed optical device 10 in a gas media 9 in accordance with the Optical Device and Deflector Formation Process. The process of forming the optical device 10, which causes the optical event of light ray 1 through the optical device 10 to the light rays 5 new direction, includes the following steps.
(a) The frequency (or wavelength) of the light ray 1 was chosen.
(b) Intensity of light ray 1 was chosen and is to move in the horizontal direction. The optical event of light ray 1 through the optical device 10 to light rays 5 new direction was chosen. An increase in momentum after encountering the optical device is not desired. The media 9 is a gas.
(c) The primary source 7 for light ray 1 was chosen at the requirements and information from (b).
(d) The location 6 of where light ray 5 is to be detected was chosen or determined.
(e) The disruption necessary of media 9 for the optical event and requirements indicated in (b) to occur included: Determining the specific molecules in media 9 that directly affect other specific molecules electronic energy states that directly affect the frequency in step (a); vibrational motion at a specific frequency were chosen for the first specific molecules; an increase in the concentration of the first specific molecules is necessary; perturbation over a specific volume 10 was chosen due to concentration and vibrational frequency.
(f) The secondary sources 2 that will cause the disruption 8 of the media 9 as indicated in (e) were chosen. The emission of the secondary sources 2 are distributed over volume 10 to have an equal effect of targeted molecules from (e) throughout volume 10. The secondary source in essence causes the vibrational motion of the first specific molecules.
(g) The tertiary sources 3, which will assist the secondary sources 2, causes the molecules of media 9 to compress within volume 10 to acquire the concentration of molecules indicated in (e). The tertiary source will cause the increase in concentration of the first specific molecules.
(h) Secondary sources 2 and tertiary sources 3 are activated to form optical device 10.
(i) Primary source 7 is activated to cause light ray 1 through the optical device the light rays 5 new direction that is detected at 6.
   With reference to FIG. 2, there is shown a cross sectional view of a formed optical device in a vacuum in accordance with the Optical Device and Deflector Formation Process. The process of forming the optical device 4, which causes the optical event of particle ray 1 through the optical device 4 to the particle rays 2 new direction, includes the following steps.
(a) The particle and momentum of the particle ray 1 was chosen.
(b) Intensity of particle ray 1 was chosen and is to move in the horizontal direction. The optical event of particle ray 1 through the optical device 4 to particle rays 2 new direction was chosen. An increase in momentum after encountering the optical device is desired. The media 10 is a vacuum.
(c) The primary source 7 of particle ray 1 was chosen at the requirements and information from (b).
(d) The location 3 of where particle ray 2 is to be detected was chosen or determined.
(e) The array 9 and 6 in vacuum 10 for the optical event and requirements indicated in (b) to occur included: two electromagnetic wavelengths (or frequencies) 9 and 6 that will directly affect the particle in step (a) was chosen; the direction, intensity and concentration of the electromagnetic waves 9 and 6 were chosen, which resembles a radial array, for the specified optical event to occur in (b).
(f) The secondary sources 5 that will cause the partial array 6 in vacuum 10 were chosen. The emission of the secondary sources 5 are distributed in volume 4 to have the radial array as described in (e).
(g) The tertiary sources 8 that will cause the partial array 9 in vacuum 10 were chosen. The emission of the tertiary sources 8 are distributed in volume 4 to have the radial array as described in (e).
(h) Secondary sources 5 and tertiary sources 8 are activated to form optical device 4.
(i) Primary source 7 is activated to cause particle ray 1 through the optical device to the particle rays 2 new direction, with an increase in momentum, which is detected at 3.
   With reference to FIG. 3, there is shown a cross sectional view of a formed deflector 10 in a gas media 9 in accordance with the Optical Device and Deflector Formation Process. The process of forming the deflector (or plane) 10, which causes the deflection of light ray 1 to light rays 5 new direction, includes the following steps.
(a) The frequency (or wavelength) of the light ray 1 was chosen.
(b) Intensity of light ray 1 was chosen and is to move at an angle to the horizontal direction deflector 10. The deflection of light ray 1 to light rays 5 new direction was chosen. The media 9 is a gas.
(c) The primary source 7 of light ray 1 was chosen at the requirements and information from (b).
(d) The location 6 of where light ray 5 is to be detected was chosen or determined.
(e) The disruption necessary of media 9 for the deflection and requirements indicated in (b) to occur included: Determining the specific molecules in media 9 whose electronic energy states directly affect the frequency in step (a) when excited; perturbation over a plane 10 was chosen.
(f) The secondary sources 2 that will cause the disruption 8 of the media 9 as indicated in (e) were chosen. The emission of the secondary sources 2 are distributed over plane 10 to have an equal effect of targeted molecules from (e) throughout plane 10. The secondary source causes the direct excitation of the electronic energy states of the specific molecules.
(g) There are no tertiary sources to assist in forming this deflector 10.
(h) Secondary sources 2 are activated to form deflector 10.
(i) Primary source 7 is activated to cause the deflection of light ray 1 to light rays 5 new direction that is detected at 6.
   With reference to FIG. 4, there is shown a cross sectional view of a formed deflector in a vacuum in accordance with the Optical Device and Deflector Formation Process. The process of forming the deflector (or plane) 4, which causes the deflection of particle ray 1 to particle rays 2 new direction, includes the following steps.
(a) The particle and momentum of the particle ray 1 was chosen.
(b) Intensity of particle ray 1 was chosen and is to move at an angle to the horizontal deflector 6. The deflection of particle ray 1 to particle rays 2 new direction was chosen. An increase in momentum after encountering the deflector is not desired. The media 10 is a vacuum.
(c) The primary source 7 of particle ray 1 was chosen at the requirements and information from (b).
(d) The location 3 of where particle ray 2 is to be detected was chosen or determined.
(e) The array 6 in vacuum 10 for the deflection and requirements indicated in (b) to occur included: one electromagnetic wavelength (or frequencies) 6 that will directly affect the particle in step (a) was chosen; the direction, intensity and concentration of the electromagnetic waves 6 over a plane 4 was chosen for the specified deflection to occur.
(f) The secondary sources 5 that will cause the partial array 6 in vacuum 10 were chosen. The emission of the secondary sources 5 are distributed in plane 4 to have the radial array as described in (e).
(g) There are no tertiary sources to assist in forming this deflector 4.
(h) Secondary sources 5 are activated to form deflector 4.
(i) Primary source 7 is activated to cause the deflection of particle ray 1 to particle rays 2 new direction that is detected at 3.
   With reference to FIG. 5, there is shown a cross sectional view of a formed optical device 12 in a gas media 16 in accordance with the Optical Device and Deflector Formation Process. The optical device affects a particle and a light ray by combining the methods of disrupting a media and creating an array. That is, the optical device 12 will cause the optical event of light ray 1 through the optical device 12 to the light rays 6 new direction, and the optical device 12 will cause the optical event of particle ray 5 through the optical device 12 to the particle rays 7 new direction includes the following steps.
(a) The frequency (or wavelength) of the light ray 1 was chosen. The particle and momentum of the particle ray 5 was chosen.
(b) Intensity of light ray 1 was chosen and is to move in the horizontal direction. The optical event of light ray 1 through the optical device 12 to light rays 6 new direction was chosen. An increase in momentum of the light ray after encountering the optical device is not desired. Intensity of particle ray 5 was chosen and is to move in the horizontal direction. The optical event of particle ray 5 through the optical device 12 to particle rays 7 new direction was chosen. An increase in momentum of the particle ray after encountering the optical device is desired. The media 16 is a gas.
(c) The primary source 8 of light ray 1 was chosen at the requirements and information from (b). The primary source 9 of particle ray 5 was chosen at the requirements and information from (b).
(d) The location 10 of where light ray 6 is to be detected was chosen or determined. The location 11 of where particle ray 7 is to be detected was chosen or determined.
(e) The disruption necessary of media 16 for the optical event and requirements indicated in (b) to occur included: Determining the specific molecules in media 16 that directly affect other specific molecules electronic energy states that directly affect the frequency in step (a); vibrational motion at a specific frequency were chosen for the first specific molecules; an increase in the concentration of the first specific molecules is necessary; perturbation over a specific volume 12 was chosen due to concentration and vibrational frequency. The array 14 and 15 in media 16 for the optical event and requirements indicated in (b) to occur included: two electromagnetic wavelengths (or frequencies) 14 and 15 that will directly affect the particle in step (a) was chosen; the direction, intensity and concentration of the electromagnetic waves 14 and 15 were chosen, which resembles a radial array, for the specified optical event to occur. The disruption of the media and introduced array were chosen not to affect each other.
(f) The secondary sources 2 that will cause the disruption 13 of the media 16 as indicated in (e) were chosen. The emission of the secondary sources 2 are distributed over volume 12 to have an equal effect of targeted molecules from (e) throughout volume 12. The secondary sources 2 in essence cause the vibrational motion of the first specific molecules. The secondary sources 3 that will cause the partial array 14 in vacuum 16 were chosen. The emission of the secondary sources 3 are distributed in volume 12 to have the radial array as described in (e).
(g) The tertiary sources 4 that will cause the partial array 15 in vacuum 16 were chosen. The emission of the tertiary sources 4 are distributed in volume 12 to have the radial array as described in (e).
(h) Secondary sources 2 and 3 and tertiary sources 4 are activated to form optical device 12.
(i) Primary source 8 is activated to cause light ray 1 through the optical device the light rays 6 new direction that is detected at 10. Primary source 9 is activated to cause particle ray 5 through the optical device to particle rays 7 new direction, with an increase in momentum, which is detected at 11.
   With reference to FIG. 6, there is shown a cross sectional view of a formed deflector (or plane) 11 in a gas media 14 in accordance with the Optical Device and Deflector Formation Process. The deflector affects a particle and a light ray by combining the methods of disrupting a media and creating an array. That is, the deflector 11 will cause the deflection of light ray 3 to the light rays 6 new direction, and the deflector 11 will cause the deflection of particle ray 1 to the particle rays 7 new direction includes the following steps.
(a) The frequency (or wavelength) of the light ray 3 was chosen. The particle and momentum of the particle ray 1 was chosen.
(b) Intensity of light ray 3 was chosen and is to move at an angle in the horizontal deflector 11. The deflection of light ray 3 to light rays 6 new direction was chosen. An increase in momentum of the light ray after encountering the optical device is not desired. Intensity of particle ray 1 was chosen and is to move at an angle in the horizontal deflector 11. The deflection of particle ray 1 to particle rays 7 new direction was chosen. An increase in momentum of the particle ray after encountering the optical device is not desired. The media 14 is a gas.
(c) The primary source 5 of light ray 3 was chosen at the requirements and information from (b). The primary source 4 of particle ray 1 was chosen at the requirements and information from (b).
(d) The location 9 of where light ray 6 is to be detected was chosen or determined. The location 8 of where particle ray 7 is to be detected was chosen or determined.
(e) The disruption necessary of media 14 for the deflection and requirements indicated in (b) to occur included: Determining the specific molecules in media 14 whose electronic energy states directly affect the frequency in step (a) when excited; perturbation over plane 11 was chosen. The array 13 in media 14 for the deflection and requirements indicated in (b) to occur included: one electromagnetic wavelength (or frequency) 13 that will directly affect the particle in step (a) was chosen; the direction, intensity and concentration of the electromagnetic waves 13 over a plane 4 was chosen, for the specified optical event to occur. The disruption of the media and introduced array were chosen not to affect each other.
(f) The secondary sources 2 that will cause the disruption 12 of the media 14 as indicated in (e) were chosen. The emission of the secondary sources 2 are distributed over plane 11 to have an equal effect of targeted molecules from (e) throughout plane 11. The secondary source 2 causes the direct excitation of the electronic energy states of the specific molecules. The secondary sources 10 that will cause the partial array 13 in media 14 were chosen. The emission of the secondary sources 10 are distributed in plane 11 to have the radial array as described in (e).
(g) There are no tertiary sources to assist in forming this deflector 11.
(h) Secondary sources 2 and 10 are activated to form deflector 11.
(i) Primary source 5 is activated to cause the deflection of light ray 3 to light rays 6 new direction that is detected at 9. Primary source 4 is activated to cause the deflection of particle ray 1 to particle rays 7 new direction that is detected at 8.
   While particular embodiments of the process have been shown and described, it will be obvious to those skilled in the art that changes and modifications may be made without departing from the process in its broader aspects that fall within the true spirit and scope of the process.

I claim:

1. A process of forming a non-permanent lens in a medium comprising the steps of:
a) Determining the wave and/or mass that will undergo the optical event or deflection.
b) Choosing the optical event or deflection to occur with the waves and/or mass from a).
c) Choosing the primary source that will emit the wave and/or mass from a) with the requirements and information from b).
d) Choosing the location of where the mass and/or wave will be detected, after encountering the optical device or deflector, considering the requirements from b).
e) Determining the disruption of media necessary for the optical event of b) to occur.
f) Determine the secondary sources that will meet the requirements stated in e).
g) Determine the tertiary sources that will assist the secondary sources in meeting the requirements stated in e).
h) Activating secondary sources and tertiary sources.
i) Activating the primary source for the optical event or deflection to occur.

2. The process of claim 1, wherein said medium (or media) is a solid liquid or gas.

3. The process of claim 1, wherein said waves can include, but not limited to, electromagnetic radiation and sound waves.

4. The process of claim 1, wherein said mass can include, but not limited to, particles, molecules and objects.

5. The process of claim 1, wherein said optical event or deflection includes determining the intensity of the wave and/or mass of the optical event or deflections.

6. The process of claim 1, wherein said optical event or deflection includes determining the direction and location of the wave and/or mass before and after encountering the formed optical device or deflector.

7. The process of claim 1, wherein said optical event or deflection includes determining the media this optical event or deflection will occur in.

8. The process of claim 1, wherein said optical event or deflection includes determining if a change in momentum is desired after encountering the optical device or deflector.

9. The process of claim 1, wherein said disruption of media necessary includes determining the specific particles, molecules and/or objects to be perturbed.

10. The process of claim 1, wherein said disruption of media necessary includes determining the perturbation of the specific particles, molecules, and/or objects in the media necessary for the optical event or deflection to occur.

11. The perturbation of the specific particles, molecules, and/or objects in the media necessary for the optical event or deflection to occur, of claim 10, can include, but not limited to, changing specific electronic energy states by direct excitation where the electronic energy states and direct excitation energy are at the same energy as the waves and/or mass from a) of claim 1; indirect excitation by changing rotational motion, changing vibrational motion, changing transverse motion, and changing the density of perturbed particles, molecules, and/or objects in the media that will cause a change in electronic energy states of the specific particles, molecules, and/or objects that are at the same energy as the waves and/or mass from a) of claim 1.

12. For the indirect excitation as stated in claim 11 the particles, molecules and/or objects in the media with changed rotational motion, vibrational motion, transverse motion, and/or density may be different than, though cause, the particles, molecules, and/or objects in the media with the changed electronic energy states.

13. The process of claim 1, wherein said disruption of media necessary includes determining the volume or plane of over which the disrupted media will occur.

14. Determining the volume or plane of over which the disrupted media will occur in claim 13 includes determining the dimensions of the volume.

15. The determination of the volume or plane as stated in claim 14 may be dependent on the perturbation of the media as stated in claim 11.

16. The process of claim 1, wherein said secondary sources include, but not limited to, waves, particles, molecules, objects and/or physical compression.

17. The process of claim 1, wherein said tertiary sources include, but not limited to, waves, particles, molecules, objects and/or physical compression.

18. A process of forming a non-permanent lens in a medium comprising the steps of
a) Determining the wave and/or mass that will undergo the optical event or deflection.
b) Choosing the optical event or deflection to occur with the waves and/or mass from a).
c) Choosing the primary source that will emit the wave and/or mass from a) with the requirements and information from b).
d) Choosing the location of where the mass and/or wave will be detected, after encountering the optical device or deflector, considering the requirements from b).
e) Determining the array necessary for the optical event or deflection of b) to occur.
f) Determining the secondary sources that will meet the requirements stated in e).
g) Determining the tertiary sources that will assist the secondary sources in meeting the requirements stated in e).
h) Activating secondary sources and tertiary sources.
i) Activating the primary source for the optical event or deflection to occur.

19. The process of claim 18, wherein said medium (or media) is a solid liquid or gas.

20. The process of claim 18, wherein said waves can include, but not limited to, electromagnetic radiation and sound waves.

21. The process of claim 18, wherein said mass can include, but not limited to, particles, molecules and objects.

22. The process of claim 18, wherein said optical event or deflection includes determining if a change in momentum is desired after encountering the optical device or deflector.

23. The process of claim 18, wherein said optical event or deflection includes determining the energies necessary for the array or arrays for the optical event or deflection to occur.

24. The process of claim 18, wherein said optical event or deflection includes determining the pattern(s) necessary for the array or arrays for the optical event or deflection to occur.

25. The determination of pattern(s) of claim 24 includes determining the intensities of the energies of each array in the pattern.

26. The determination of patterns) of claim 24 includes determining patterns in all three dimensions.

27. The determination of pattern(s) of claim 24 includes determining the direction of each array in the pattern.

28. The determination of pattern(s) of claim 24 includes determining the volume or plane necessary for the optical event or deflection.

29. The process of claim 18, wherein said secondary sources include, but not limited to, waves, particles, molecules, objects and/or physical compression.

30. The process of claim 18, wherein said tertiary sources include, but not limited to, waves, particles, molecules, objects and/or physical compression.

31. A process of forming a non-permanent lens in a vacuum comprising the steps of
a) Determine the wave and/or mass that will undergo the optical event or deflection.
b) Choose the optical event or deflection to occur with the waves and/or mass from a).
c) Choose the primary source that will emit the wave and/or mass from a) with the requirements and information from b).
d) Choose the location of where the mass and/or wave will be detected, after encountering the optical device or deflector, considering the requirements from b).
e) Determine the array necessary for the optical event of b) to occur.
f) Determine the secondary sources that will meet the requirements stated in e).
g) Determine the tertiary sources that will assist the secondary sources in meeting the requirements stated in e).
h) Activate secondary sources and tertiary sources
i) Activate the primary source for the optical event or deflection to occur

32. The process of claim 31, wherein said waves can include, but not limited to, electromagnetic radiation and sound waves.

33. The process of claim 31, wherein said mass can include, but not limited to, particles, molecules and objects.

34. The process of claim 31, wherein said optical event or deflection includes determining if a change in momentum is desired after encountering the optical device or deflector.

35. The process of claim 31, wherein said optical event or deflection includes determining the energies necessary for the array or arrays for the optical event or deflection to occur.

36. The process of claim 31, wherein said optical event or deflection includes determining the pattern(s) necessary for the array or arrays for the optical event or deflection to occur.

37. The determination of pattern(s) of claim 36 includes determining the intensities of the energies of each array in the pattern.

38. The determination of pattern(s) of claim 36 includes determining patterns in all three dimensions.

39. The determination of pattern(s) of claim 36 includes determining the direction of each array in the pattern.

40. The determination of pattern(s) of claim 36 includes determining the volume or plane necessary for the optical event or deflection.

41. The process of claim 31, wherein said secondary sources include, but not limited to, waves, particles, molecules, objects and/or physical compression.

42. The process of claim 31, wherein said tertiary sources include, but not limited to, waves, particles, molecules and/or objects.

43. A process of forming a non-permanent lens in a medium comprising the steps of:
a) Determining the wave and/or mass that will undergo the optical event or deflection.
b) Choosing the optical event or deflection to occur with the waves and/or mass from a).
c) Choosing the primary source that will emit the wave and/or mass from a) with the requirements and information from b).
d) Choosing the location of where the mass and/or wave will be detected, after encountering the optical device or deflector, considering the requirements from b).
e) Determining the disruption of media and the array or arrays necessary for the optical event or deflection of b) to occur.
f) Determine the secondary sources that will meet the requirements stated in e).
g) Determine the tertiary sources that will assist the secondary sources in meeting the requirements stated in e).
h) Activating secondary sources and tertiary sources.
i) Activating the primary source for the optical event or deflection to occur.

44. The process of claim 43, wherein said medium (or media) is a solid liquid or gas.

45. The process of claim 43, wherein said waves can include, but not limited to, electromagnetic radiation and sound waves.

46. The process of claim 43, wherein said mass can include, but not limited to, particles, molecules and objects.

47. The process of claim 43, wherein said optical event or deflection includes determining the intensity of the wave and/or mass of the optical event or deflections.

48. The process of claim 43, wherein said optical event or deflection includes determining the direction and location of the wave and/or mass before and after encountering the formed optical device or deflector.

49. The process of claim 43, wherein said optical event or deflection includes determining the media this optical event or deflection will occur in.

50. The process of claim 43, wherein said optical event or deflection includes determining if a change in momentum is desired after encountering the optical device or deflector.

51. The process of claim 43, wherein said determining the disruption of media and array necessary for the optical event or deflection of b), in claim 43, to occur includes determining the type of array and disruption of media to work together for the optical event to occur.

52. The process of claim 43, wherein said disruption of media necessary includes determining the specific particles, molecules and/or objects to be perturbed.

53. The process of claim 43, wherein said disruption of media necessary includes determining the perturbation of the specific particles, molecules, and/or objects in the media necessary for the optical event or deflection to occur.

54. The perturbation of the specific particles, molecules, and/or objects in the media necessary for the optical event or deflection to occur, of claim 53, can include, but not limited to, changing specific electronic energy states by direct excitation where the electronic energy states and direct excitation energy are at the same energy as the waves and/or mass from a) of claim 43; indirect excitation by changing rotational motion, changing vibrational motion, changing transverse motion, and changing the density of perturbed particles, molecules, and/or objects in the media that will cause a change in electronic energy states of the specific particles, molecules, and/or objects that are at the same energy as the waves and/or mass from a) of claim 43.

55. For the indirect excitation as stated in claim 54 the particles, molecules and/or objects in the media with changed rotational motion, vibrational motion, transverse motion, and/or density may be different than, though cause, the particles, molecules, and/or objects in the media with the changed electronic energy states.

56. The process of claim 43, wherein said disruption of media necessary includes determining the volume or plane of over which the disrupted media will occur.

57. Determining the volume or plane of over which the disrupted media will occur in claim 56 includes determining the dimensions of the volume.

58. The determination of the volume or plane as stated in claim 57 may be dependent on the perturbation of the media as stated in claim 54.

59. The process of claim 43, wherein said determining the array or arrays necessary for optical event or deflection includes determining the energies for the array or arrays necessary for the optical event or deflection to occur.

60. The process of claim 43, wherein said determining the array or arrays necessary for optical event or deflection includes determining the pattern(s) necessary for the array or arrays for the optical event or deflection to occur.

61. The determination of pattern(s) of claim 60 includes determining the intensities of the energies of each array in the pattern.

62. The determination of pattern(s) of claim 60 includes determining patterns in all three dimensions.

63. The determination of pattern(s) of claim 60 includes determining the direction of each array in the pattern.

64. The determination of pattern(s) of claim 60 includes determining the volume or plane necessary for the optical event or deflection.

65. The process of claim 43, wherein said secondary sources include, but not limited to, waves, particles, molecules, objects and/or physical compression.

66. The process of claim 43, wherein said tertiary sources include, but not limited to, waves, particles, molecules, objects and/or physical compression.
